(19) United States
(12) Patent Application Publication
(10) Pub. No.: US 2016/0195721 A1
(43) Pub. Date: Jul. 7, 2016

(54) SYSTEM, METHOD, AND APPARATUS FOR DISPLAYING AN IMAGE USING A CURVED MIRROR AND PARTIALLY TRANSPARENT PLATE

(71) Applicant: Avegant Corporation, Ann Arbor, MI (US)

(72) Inventor: Allan Thomas Evans, Redwood City, CA (US)

(21) Appl. No.: 14/590,953

(22) Filed: Jan. 6, 2015

(51) Int. Cl. G02B 27/01

(52) U.S. Cl. CPC G02B 27/0172; G02B 27/0176

(57) ABSTRACT

A system (100), method (900), and apparatus (110) for displaying an image (880). The system (100) can use a curved mirror (420) in conjunction with a partially transparent plate (430) to project an image directly on the eyes (92) of a user (90). The curved mirror (420) and plate (430) combination can also be used for additional functions in a VRD visor apparatus (116) such as the ability to operate in a tracking mode (123) where the eyes (92) of the viewer (96) are tracked and the ability to operate in in augmentation mode (122) where the viewer (96) can see the displayed image (880) overlaying a view of their physical environment (650).

### RELATED APPLICATIONS

This utility patent application both (i) claims priority to and (ii) incorporates by reference in its entirety, the provisional patent application titled “NEAR-EYE DISPLAY APPARATUS AND METHOD” (Ser. No. 61/924,209) that was filed on Jan. 6, 2014.

### BACKGROUND OF THE INVENTION

The invention is system, method, and apparatus (collectively the “system”) for displaying an image. More specifically, the system is a virtual retinal display system that projects images onto the eyes of a viewer using a curved mirror and a partially transparent plate.

A virtual retinal display (VRD) is like shining an 80 inch television image directly on the viewer's eyes. In an era where large screen TVs keep getting larger and larger, and mobile media consumption continues to grow through the use of smart phones and tablet computers, VRDs avail themselves to the advantages of both worlds by combining a large screen TV experience with the mobility of a set of headphones.

VRDs can potentially open a large universe of much desired functionality to users. However, coordinating such different functions is no trivial task. Light is always a tricky resource to control. In a head mounted display such as a VRD, there isn't a lot of room in the device if one wants to have a device that is a sufficiently small for convenient mobile use.

There is a need for a “traffic cop” to manage the different light pathways that can be useful to manage the different light pathways in a VRD display or other forms of head mounted displays.

### SUMMARY OF THE INVENTION

The invention is system, method, and apparatus (collectively the “system”) for displaying an image. More specifically, the system is a virtual retinal display system that projects images onto the eyes of a viewer using a curved mirror and a partially transparent plate.

The configuration of a curved mirror in conjunction with a partially reflective plate is an effective way to direct the desired image directly onto the retinas of the viewer. If desired, such a configuration can also be used to: (1) direct light to a tracking assembly for the purposes of monitoring the eye movement of the viewer; and (2) create a media experience that allows for augmented reality (i.e. media displays overlaying a view of the physical environment that is visible to the user).

### BRIEF DESCRIPTION OF THE DRAWINGS

Many features and inventive aspects of the system are illustrated in the various drawings described briefly below. All components illustrated in the drawings below and associated with element numbers are named and described in Table 1 provided in the Detailed Description section.

FIG. 1a is a block diagram illustrating an example of a side view of a curved mirror secured to a partially reflective and partially transparent plate.

FIGS. 1b-1f are block diagrams illustrating an example of the life cycle of light in the system (i.e. the illumination path), beginning with the generation of light by the illumination assembly to the projection of the image on the eyes of the viewer.

FIG. 1b is a block diagram illustrating an example the transmission of light from the illumination assembly to the imaging assembly.

FIG. 1c is a block diagram illustrating an example of the transmission of an image by the imaging assembly to the plate.

FIG. 1d is a block diagram illustrating the partially transparent and partially reflective nature of the plate, with some being reflected back to the curved mirror and other light passing up through the plate.

FIG. 1e is a block diagram illustrating an example of light previously reflected by the plate towards the mirror being reflected back towards the plate.

FIG. 1f is a block diagram illustrating an example of some light passing through the plate while other light is reflected back towards the imaging assembly.

FIGS. 1g-1h are block diagrams illustrating the infrared light pathway utilized by the tracking assembly.

FIG. 1g is a block diagram illustrating infrared light from the eye reaching the plate.

FIG. 1h is a block diagram illustrating infrared light reflecting off of the plate to the tracking assembly.

FIGS. 1i-1k are block diagrams illustrating the illumination pathway for light exterior light to reach the eyes of the viewer while viewing an image created by the imaging assembly.

FIG. 1i is a block diagram illustrating an example of an exterior environment image reaching the curved mirror.

FIG. 1j is a block diagram illustrating an example of an exterior environment image reaching the partially transparent plate.

FIG. 1k is a block diagram illustrating an example of the exterior light reaching the eye of the viewer.

FIG. 1l is front view diagram illustrating an example of a plate-curved mirror configuration as what would face the eye of a viewer.

FIG. 1m is a block diagram illustrating an example of the types of roles that a plate-curved mirror configuration can perform with respect to displaying an image, eye tracking, and enabling an exterior environment image to reach the eye of the viewer.

FIG. 1n is a process flow diagram illustrating an example of a user using the system.

FIG. 2a is a block diagram illustrating an example of different assemblies that can be present in the operation of the system, such as an illumination assembly, an imaging assembly, and a projection assembly.

FIG. 2b is a block diagram illustrating an example of a configuration that includes an optional tracking assembly.

FIG. 2c is a block diagram illustrating an example of a configuration that includes an optional augmentation assembly.

FIG. 2d is a block diagram illustrating an example of a configuration that includes both an optional tracking assembly and an optional augmentation assembly.

FIG. 2e is a hierarchy diagram illustrating an example of different components that can be included in an illumination assembly.

FIG. 2f is a hierarchy diagram illustrating an example of different components that can be included in an imaging assembly.

FIG. 2g is a hierarchy diagram illustrating an example of different components that can be included in a projection assembly.

FIG. 2h is a hierarchy diagram illustrating an example of different components that can be included in a tracking assembly.

FIG. 2i is a hierarchy diagram illustrating an example of different components that can be included in an augmentation assembly.

FIG. 2j is a hierarchy diagram illustrating examples of different types of supporting components that can be included in the structure and function of the system.

FIG. 2k is a block diagram illustrating an example of the light flow used to support the functionality of the tracking assembly.

FIG. 2l is a flow chart diagram illustrating an example of projecting an image.

FIG. 3a is a block diagram illustrating an example of a DLP system using the plate-curved mirror configuration.

FIG. 3b is a block diagram illustrating a more detailed example of a DLP system using the plate-curved mirror configuration.

FIG. 3c is a block diagram illustrating an example of an LCOS system using multiple diffusers of light.

FIG. 4a is diagram of a perspective view of a VRD apparatus embodiment of the system.

FIG. 4b is environmental diagram illustrating an example of a side view of a user wearing a VRD apparatus embodying the system.

FIG. 4c is an architectural diagram illustrating an example of the components that can be used in a VRD apparatus.

FIG. 5a is a hierarchy diagram illustrating an example of the different categories of display systems that the innovative system can be potentially be implemented in, ranging from giant systems such as stadium scoreboards to VRD visor systems that project visual images directly on the retina of an individual user.

FIG. 5b is a hierarchy diagram illustrating an example of different categories of display apparatuses that closely mirrors the systems of FIG. 5a.

FIG. 5c is a perspective view diagram illustrating an example of user wearing a VRD visor apparatus.

FIG. 5d is hierarchy diagram illustrating an example of different display/projection technologies that can be incorporated into the system.

FIG. 5e is a hierarchy diagram illustrating an example of different operating modes of the system pertaining to immersion and augmentation.

FIG. 5f is a hierarchy diagram illustrating an example of different operating modes of the system pertaining to the use of sensors to detect attributes of the user and/or the user's use of the system.

FIG. 5g is a hierarchy diagram illustrating an example of different categories of system implementation based on whether or not the device(s) are integrated with media player components.

FIG. 5h is hierarchy diagram illustrating an example of two roles or types of users, a viewer of an image and an operator of the system.

FIG. 5i is a hierarchy diagram illustrating an example of different attributes that can be associated with media content.

FIG. 5j is a hierarchy diagram illustrating examples of different contexts of images.

### DETAILED DESCRIPTION

The invention is system, method, and apparatus (collectively the “system”) for displaying an image. More specifically, the system is a virtual retinal display system that projects images onto the eyes of a viewer using a curved mirror and a partially transparent plate.

### I. OVERVIEW

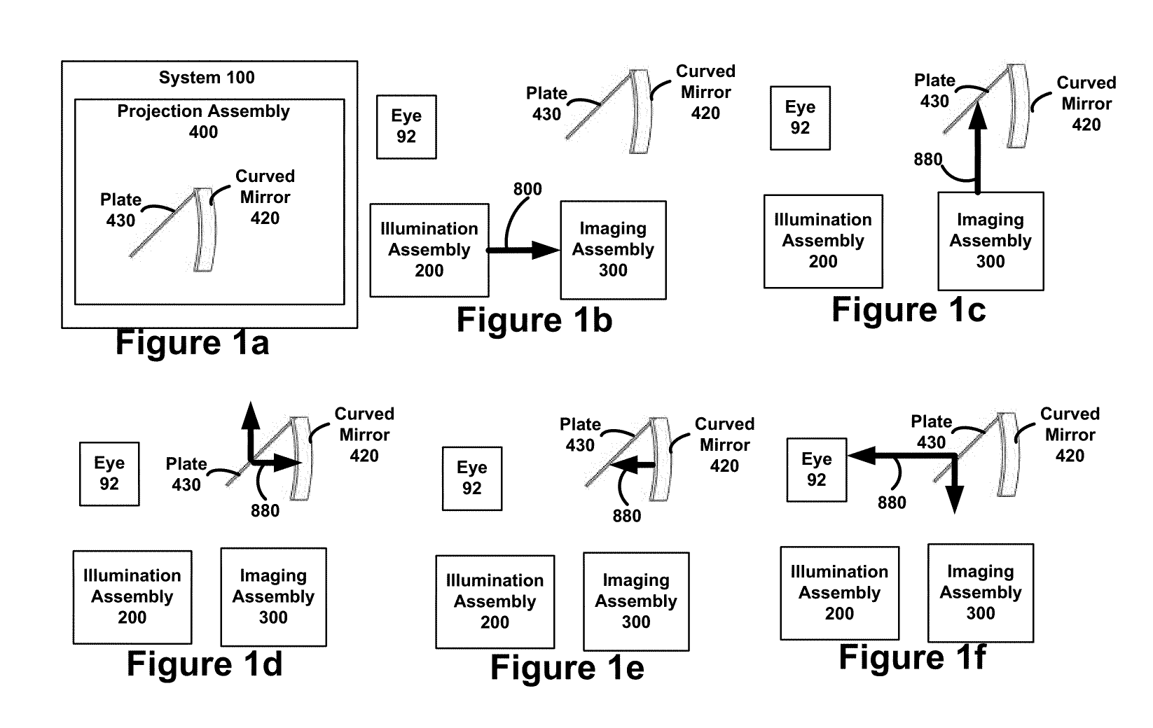

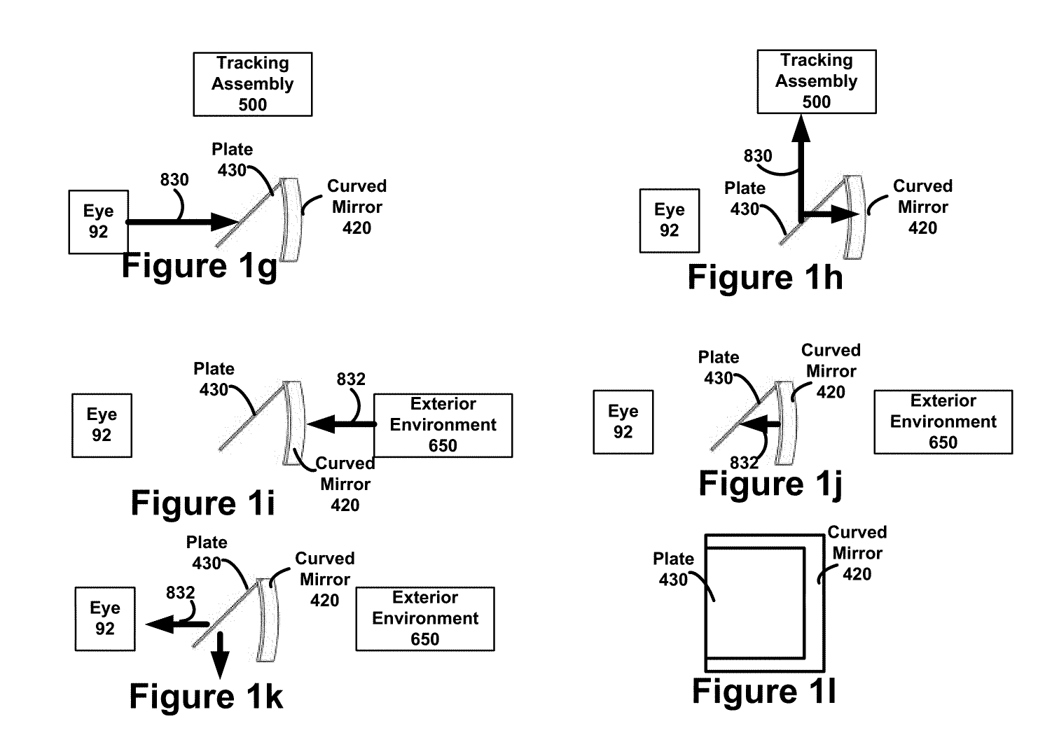

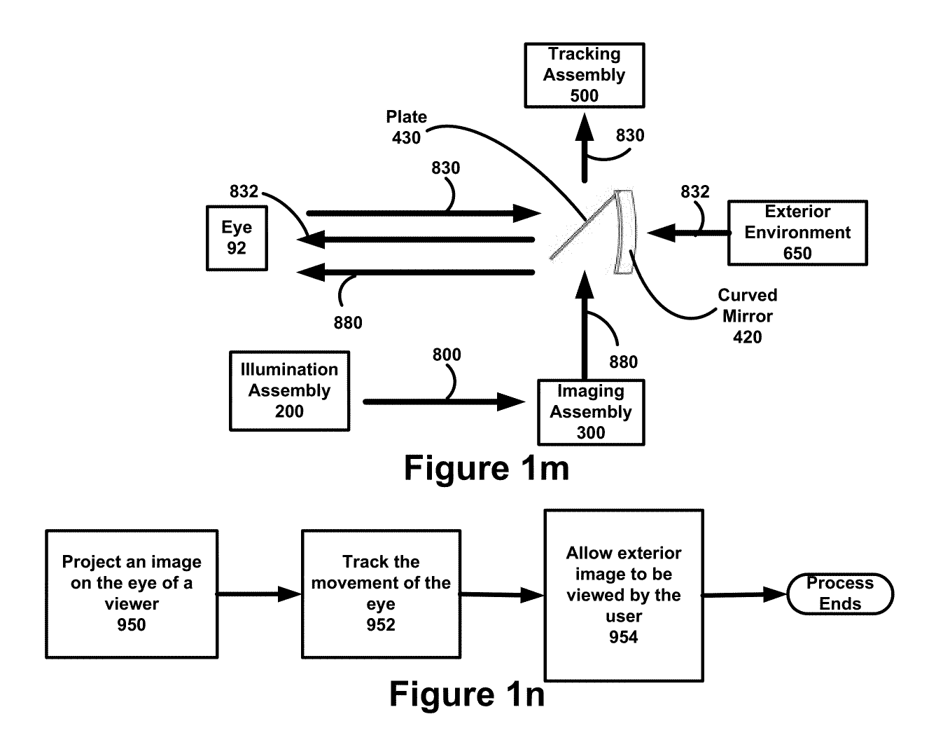

FIG. 1a is a block diagram illustrating a partial example of a system 100. The illustration discloses a two components of a projection assembly 400 that can be highly useful tools for directing light. The two components are an at least partially transparent plate 430 (which is also by definition, at least partially reflective) and a curved mirror 420. In many instances the curved mirror 420 will be a half silvered mirror that is at least partially transparent. These two components can comprise a highly desirable projection assembly 400 that serves to project an image on the eye of a viewer. This configuration of components can also be used to enable eye tracking by a tracking assembly and/or augmented reality by an augmentation assembly. The plate 430 and curved mirror 420 can serve as highly effective directors of “traffic” in terms of the movement of light in the system.

A. Displaying an Image on the Eye of a Viewer

FIGS. 1b-1f are block diagrams illustrating an example of the life cycle of light in the system 100 (i.e. the illumination path), beginning with the generation of light by the illumination assembly to the projection of the image on the eyes of the viewer.

FIG. 1b is a block diagram illustrating an example the transmission of light 800 from the illumination assembly 200 to the imaging assembly 300.

FIG. 1c is a block diagram illustrating an example of the transmission of an image 880 (embodied in light) by the imaging assembly 300 to the plate 430.

FIG. 1d is a block diagram illustrating the partially transparent and partially reflective nature of the plate 430, with some being reflected back to the curved mirror 420 and other light passing up through the plate 430.

FIG. 1e is a block diagram illustrating an example of light 880 previously reflected by the plate 430 towards the mirror 420 being reflected back towards the plate 430.

FIG. 1f is a block diagram illustrating an example of some light 880 passing through the plate 430 while other light is reflected back towards the imaging assembly 300.

B. Tracking the Movement of an Eye

Some embodiments of the system 100 can include a tracking assembly. The tracking assembly allows for the system 100 to track the movement of the eyes 92 of the viewer 96 while the viewer 96 is viewing an image 880. FIGS. 1g-1h are block diagrams illustrating the infrared light pathway utilized by the tracking assembly 500.

FIG. 1g is a block diagram illustrating infrared light 830 from the eye 92 reaching the plate 430.

FIG. 1h is a block diagram illustrating infrared light 830 reflecting off of the plate 430 to the tracking assembly 500. Infrared light 832 or other types of light can be generated by a light source or lamp in the tracking assembly 500.

C. Augmented Reality

The system 100 can be potentially used in either an augmented reality mode (where the outside world and the displayed images are seen simultaneously by the viewer) or an immersion mode which blocks out exterior images. FIGS. 1i-1k are block diagrams illustrating the illumination pathway for light exterior light to reach the eyes of the viewer while viewing an image created by the imaging assembly.

FIG. 1i is a block diagram illustrating an example of an exterior environment image 650 reaching the curved mirror.

FIG. 1j is a block diagram illustrating an example of an exterior environment image 650 reaching the partially transparent plate.

FIG. 1k is a block diagram illustrating an example of the exterior light 830 embodying the exterior environment image 650 reaches the eye 92 of the viewer 96.

FIG. 1l is front view diagram illustrating an example of a plate-curved mirror configuration as what would face the eye of a viewer.

D. Aggregate Functionality

FIG. 1m is an input-output diagram illustrating an example of the types of light 800 that a plate-curved mirror configuration can perform with respect to displaying an image, eye tracking, and enabling an exterior environment image to reach the eye of the viewer. Some embodiments of the system 100 will not include either tracking or augmented reality, but the plate 430 and curved mirror 420 can be a useful way to implement all three functions. The configuration can serve as an effective “traffic cop” for the various flows of light in the system 100.

FIG. 1n is a flow chart diagram illustrating an example of all three functions being used. At 950, an image 880 is projected on the eye(s) 92 of the viewer 96. At 960, the system 100 tracks the movement of the viewer's 96 eyes 92 as the image 880 (or more likely, images 880) are being viewed. At 954, the system 100 can allow an exterior environment image 650 to reach the eye 92 of the viewer and be displayed simultaneously view the displayed image 880.

### II. ASSEMBLIES AND COMPONENTS

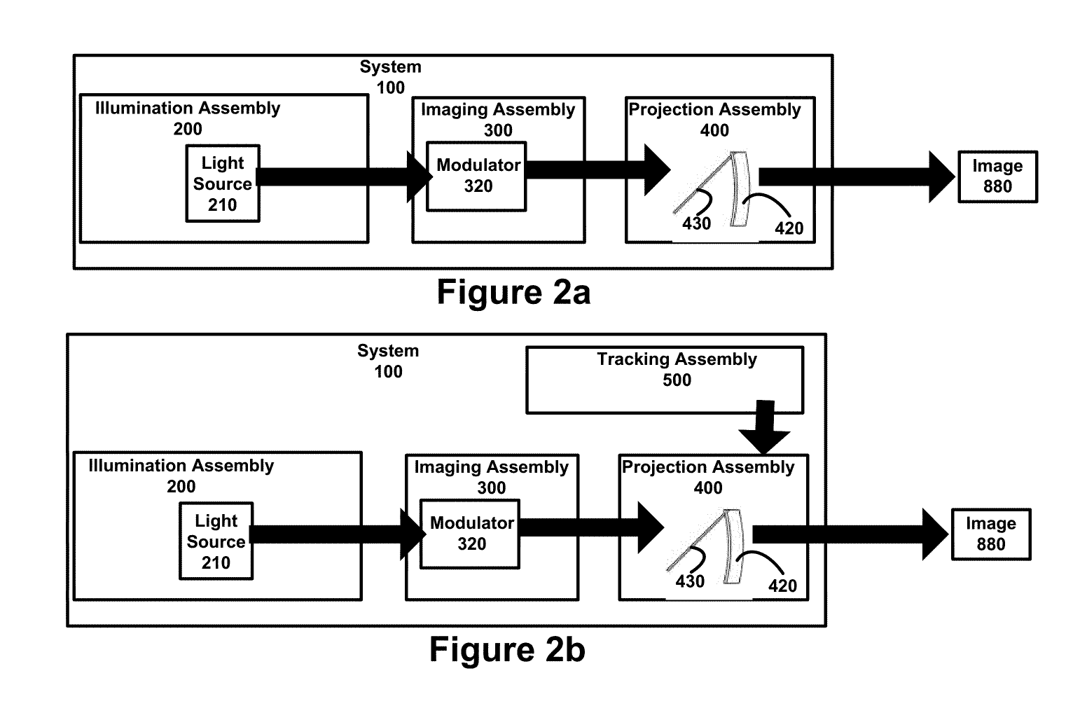

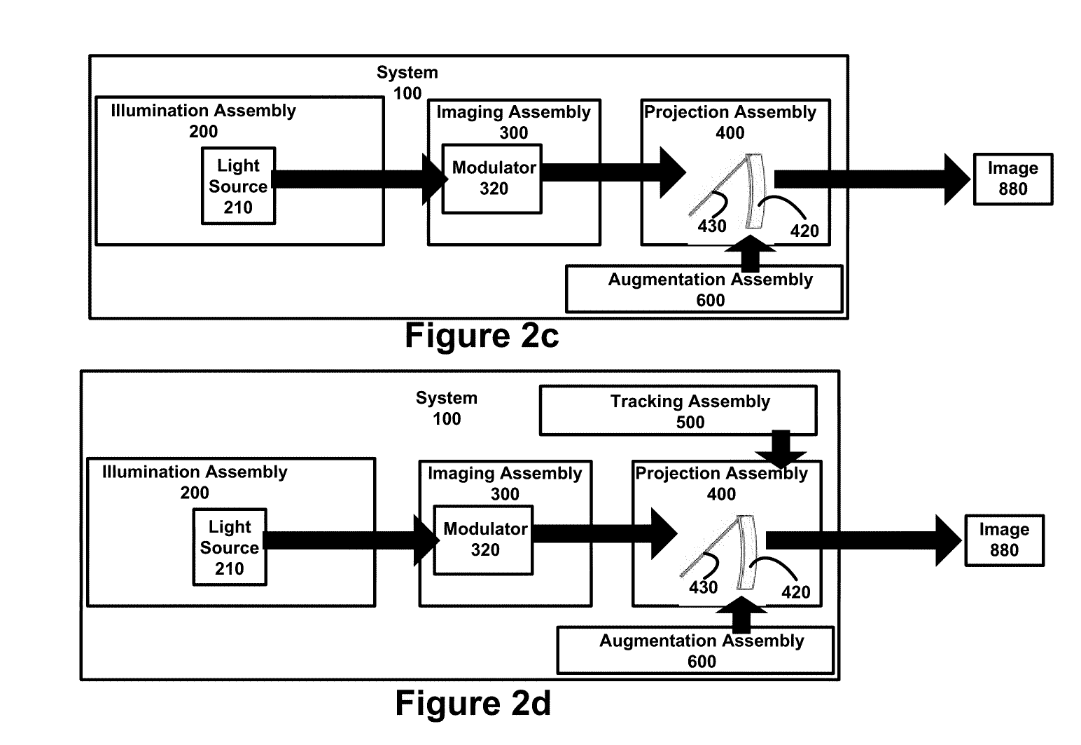

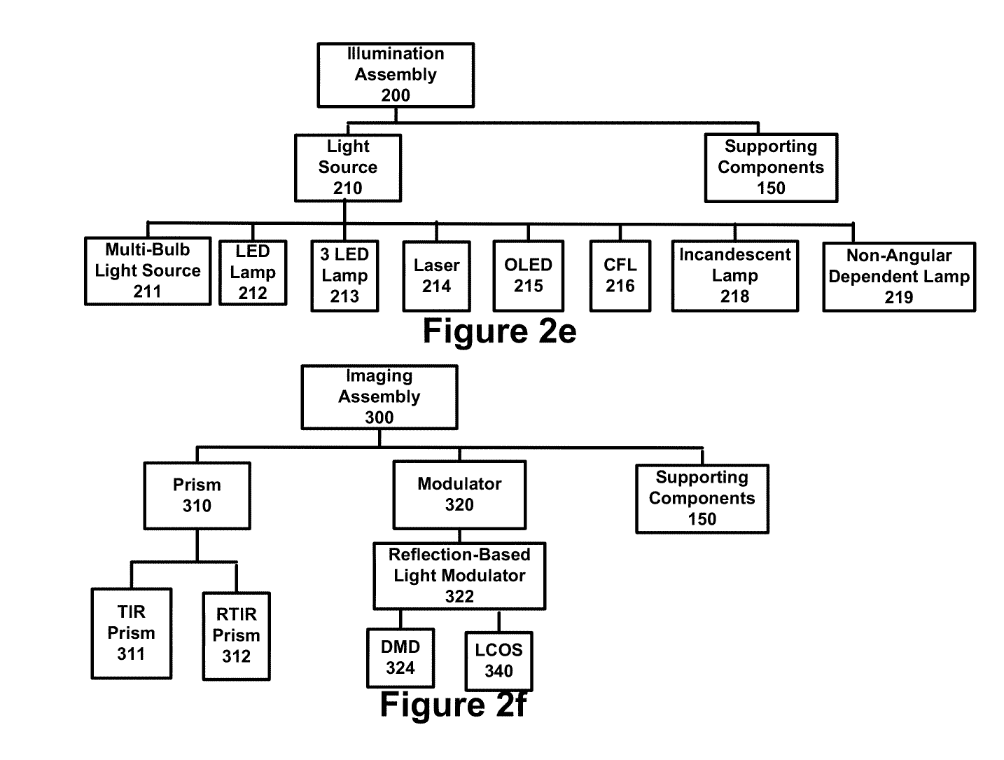

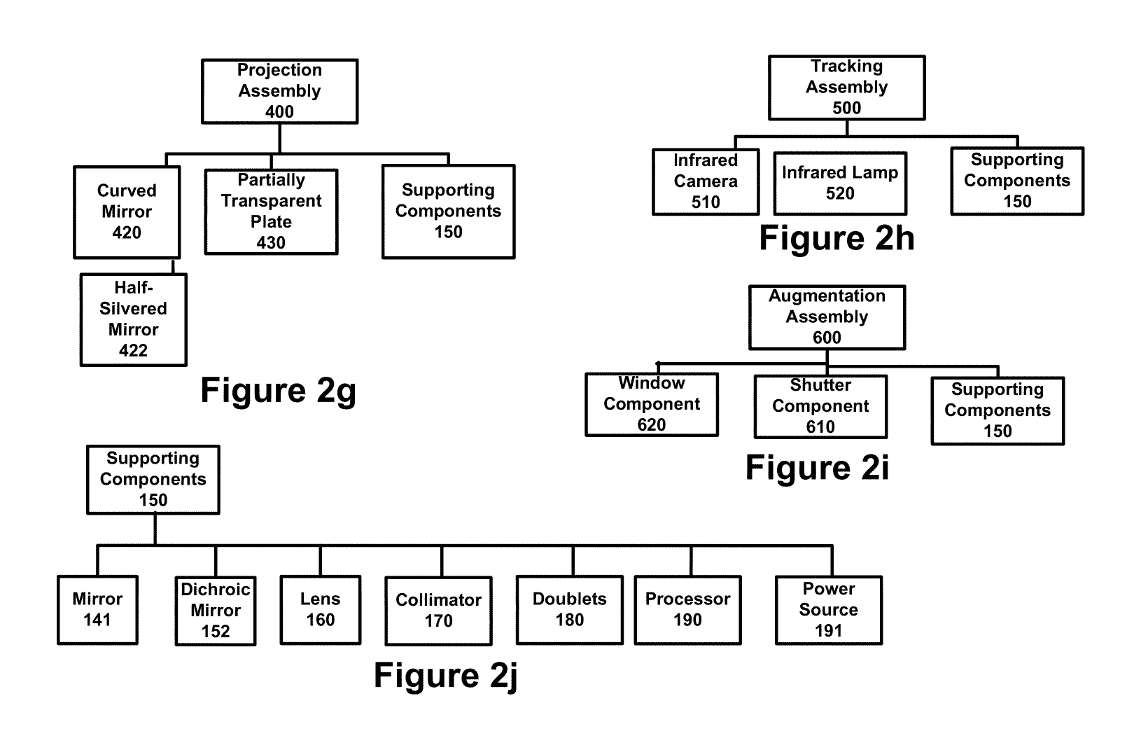

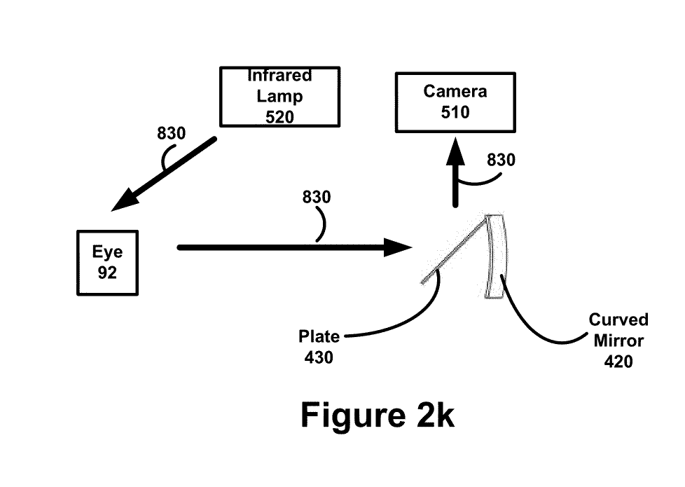

The system 100 can be described in terms of assemblies of components that perform various functions in support of the operation of the system 100. FIG. 2a is a block diagram illustrating an example of different assemblies that can be present in the operation of the system 100, such as an illumination assembly 200, an imaging assembly 300, and a projection assembly 400. The illumination assembly 200 includes a light source 210 that supplies the light 800 for the image 880. A modulator 320 in the imaging assembly 300 modulates the incoming light 800 to form an image 880. At this stage, the image 880 can sometimes be referred to as an interim image 850 since it is still be modified, focused, or otherwise impacted by the processing of the system 100 in certain ways. Nonetheless, the modulator 320 is responsible for transforming the raw material of light 800 into something for viewers 96 to see. A projection assembly 300, including the at least partially transparent plate 430 and the curved mirror 420 receive the image 880 from the imaging assembly 300 and project it to the viewer 96. In the case of a VRD visor apparatus 116, the image 880 is projected onto the eye 92 of the viewer 96.

As illustrated in FIGS. 2b, 2c, and 2d, the system 100 may also include a tracking assembly 500 to track the movement of the viewer's eye. This can be done while images 880 are being displayed, or when no images 880 are being displayed. The system 100 may also include an augmentation assembly to allow the viewer 96 to see both the image 880 from the media content as well as the exterior environment image 650. This can be referred to as augmented reality.

A. Illumination Assembly

An illumination assembly 200 performs the function of supplying light 800 to the system 100 so that an image 880 can be displayed. FIG. 2e is a hierarchy diagram illustrating an example of different components that can be included in the illumination assembly 200. Those components can include but are not limited a wide range of light sources 210, a color wheel or other type of colorizing filter, a diffuser, and a variety of supporting components 150. Examples of light sources 210 can include but are such as a multi-bulb light source 211, an LED lamp 212, a 3 LED lamp 213, a laser 214, an OLED 215, a CFL 216, an incandescent lamp 218, and a non-angular dependent lamp 219. The light source 210 is where light 800 is generated and moves throughout the rest of the system 100. Thus, each light source is a location 230 for the origination of light 800.

B. Imaging Assembly

An imaging assembly 300 performs the function of creating the image 880 from the light 800 supplied by the illumination assembly 200. A modulator 320 can transform the light 800 supplied by the illumination assembly 200 into the image 880 that is displayed by the system 100. The image 880 generated by the imaging assembly 300 can sometimes be referred to as an interim image 850 because the image 850 may be focused or otherwise modified to some degree before it is directed to the location where it can be experienced by one or more users 90.

Imaging assemblies 300 can vary significantly based on the type of technology used to create the image. Display technologies such as DLP (digital light processing), LCD (liquid-crystal display), LCOS (liquid crystal on silicon), and other methodologies can involve substantially different components in the imaging assembly 300.

FIG. 2f is a hierarchy diagram illustrating an example of different components that can be utilized in the imaging assembly 300 for the system 100. A prism 310 can be very useful component in directing light to and/or from the modulator 320. DLP applications will typically use an array of TIR prisms 311 or RTIR prisms 312 to direct light to and from a DMD 324.

A light modulator 320 is the device that modifies or alters the light 800, creating the image 880 that is to be displayed. Modulators 320 can operate using a variety of different attributes of the modulator 320. A reflection-based modulator 322 uses the reflective-attributes of the modulator 320 to fashion an image 880 from the supplied light 800. Examples of reflection-based modulators 322 include but are not limited to the DMD 324 of a DLP display and some LCOS (liquid crystal on silicon) panels 340. A transmissive-based modulator 321 uses the transmissive-attributes of the modulator 320 to fashion an image 880 from the supplied light 800. Examples of transmissive-based modulators 321 include but are not limited to the LCD (liquid crystal display) 330 of an LCD display and some LCOS panels 340. The imaging assembly 300 for an LCOS or LCD system 100 will typically have a combiner cube 350 or some similar device for integrating the different one-color images into a single image 880.

The imaging assembly 300 can also include a wide variety of supporting components 150.

C. Projection Assembly

The projection assembly 400 can perform the task of directing the image 880 to its final destination in the system 100 where it can be accessed by users 90. In many instances, the image 880 created by the imaging assembly 300 will be modified in at least some minor ways between the creation of the image 880 by the modulator 320 and the display of the image 880 to the user 90. Thus, the image 880 generated by the modulator 320 of the imaging assembly 400 may only be an interim image 850, not the final version of the image 880 that is actually displayed to the user 90.

FIG. 2g is a hierarchy diagram illustrating an example of different components that can be part of the projection assembly 400. The curved mirror 420 (which will typically be a half-silvered mirror 422 is augmentation is a desired capability) and a partially transparent plate 430 can be accompanied by a variety of supporting components 150 that can fairly be characterized as conventional optics.

D. Tracking/Sensing Assembly

As illustrated in FIG. 2h, the tracking assembly 500 will typically include a lamp such as an infrared lamp 520, a camera such as an infrared camera 520 and a variety of supporting components. A quad photodiode array or a CCD may be included in the assembly 500 for the purpose of eye tracking. FIG. 2k is an input output diagram illustrating an example of the light flow that can be implemented by the tracking assembly 830. A lamp 520 generates light 830 so that the camera 510 can “see” the eye 92 of the viewer 96. Since the generated light 830 is serving as a type of flash and is not being used to project an image, the infrared lamp 520 can be positioned in a variety of different places. One reason to use infrared light 830 is that it will not interfere with the image 880 of the exterior environment image 650 since infrared light 830 is invisible to the viewer 96.

F. Augmentation Assembly

An augmentation assembly 600 provides the capability of viewing external environment images 650 simultaneously with the displayed images 880 generated from the media or streaming source. As illustrated in FIG. 2i, the augmentation assembly 2i can include a window component 620 that provides for the exterior light 650 to reach the viewer's eye, a shutter component 610 that provides for closing or blocking the window component 620, and a variety of supporting components 150 if necessary or helpful to the particular context.

G. Supporting Components

Light 800 can be a challenging resource to manage. Light 800 moves quickly and Cannot be Constrained in the Same Way that Most Inputs or Raw Materials can be. FIG. 2j is a hierarchy diagram illustrating an example of some supporting components 150, many of which are conventional optical components. Any display technology application will involve conventional optical components such as mirrors 141 (including dichroic mirrors 152) lenses 160, collimators 170, and doublets 180. Similarly, any powered device requires a power source 191 and a device capable of displaying an image 880 is likely to have a processor 190.

H. Process Flow View

The system 100 can be described as the interconnected functionality of an illumination assembly 200, an imaging assembly 300, and a projection assembly 400. However, the system 100 can also be described in terms of a method 900 that includes an illumination process 910, an imaging process 920, and a projection process 930. Similarly, the functions of the tracking assembly 500 and the augmentation assembly 600 can also be described and characterized in terms of processes.

### III. DIFFERENT DISPLAY TECHNOLOGIES

The system 100 can be implemented with respect to a wide variety of different display technologies, including but not limited to DLP and LCOS.

A. DLP Embodiments

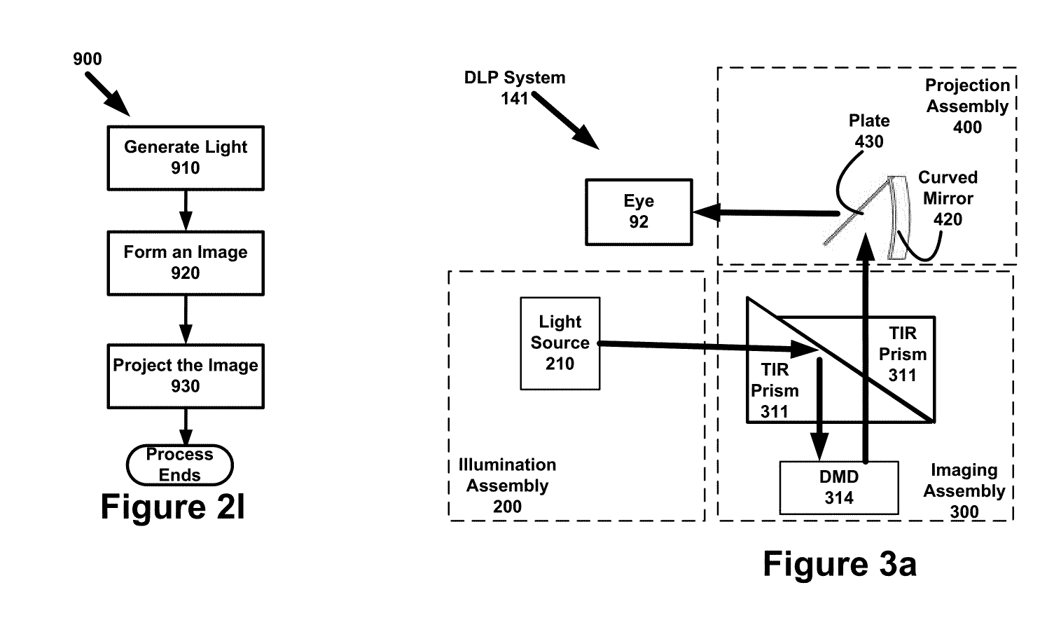

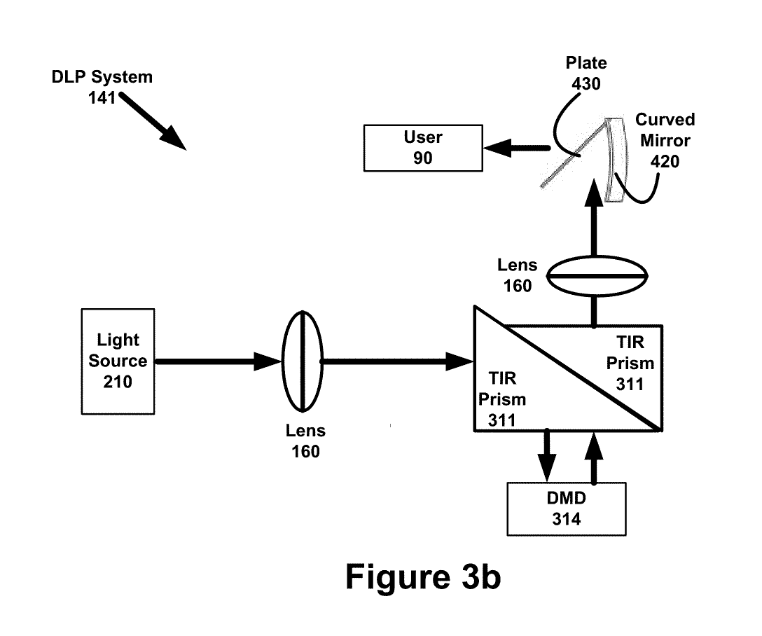

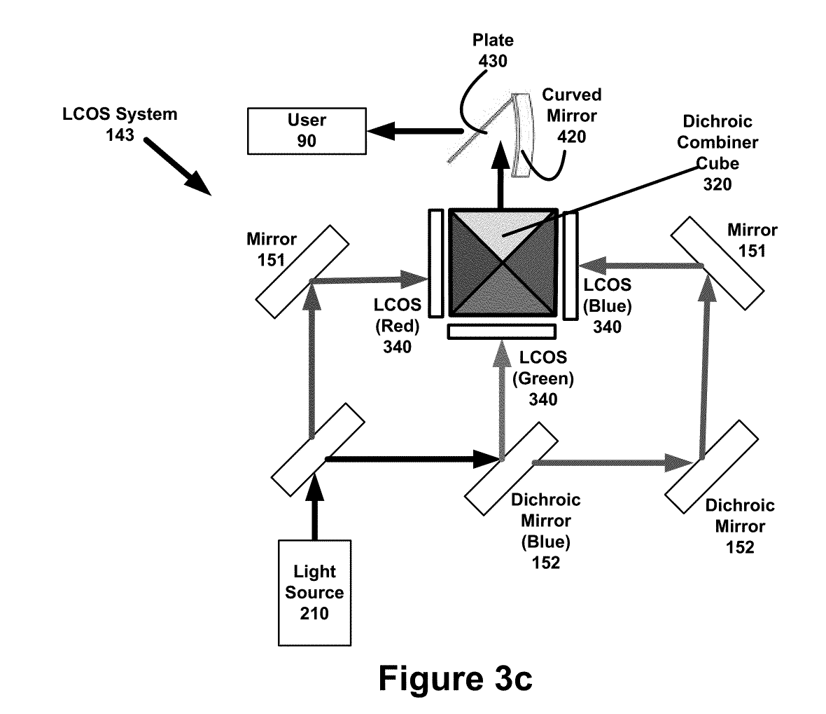

FIG. 3a illustrates an example of a DLP system 141, i.e. an embodiment of the system 100 that utilizes DLP optical elements. DLP systems 141 utilize a DMD 314 (digital micromirror device) comprised of millions of tiny mirrors as the modulator 320. Each micro mirror in the DMD 314 can pertain to a particular pixel in the image 880.

As discussed above, the illumination assembly 200 includes a light source 210 for supplying light 800. The light 800 then passes to the imaging assembly 300. Two TIR prisms 311 direct the light 800 to the DMD 314, the DMD 314 creates an image 880 with that light 800, and the TIR prisms 311 then direct the light 800 embodying the image 880 to the configuration of the plate 430 and curved mirror 420 which together function to deliver the image 880 onto the eye 92 of the viewer 96.

FIG. 3b is a more detailed example of a DLP system 141. In that it includes additional lenses 160 that can be helpful to direct the flow of light. Similarly, components such as a color wheel or other similar components could be added to enable the image 880 to be in color. A lens 160 is positioned before the display 410 to modify/focus image 880 before providing the image 880 to the viewer 96.

B. LCD Embodiments

FIG. 3d is a diagram illustrating an example of an LCOS system 143. LCOS is a hybrid between DLP and LCD. LCOS stands for liquid crystal on silicon displays. LCD stands for liquid crystal display. The modulator 320 in an LCD system 142 is one or more LCD panels 330 comprised of liquid crystals which are electronically manipulated to form the image 880. The LCOS panel 340 is an LCD panel that includes a computer chip analogous to the chip found in a DMD 314 of a DLP application.

The illumination assembly 200 in an LCOS system 143 typically include a variety of dichroic mirrors 152 that separate light 800 into three component colors, typically red, green, and blue—the same colors on many color wheels 240 found in a DLP application.

The LCDs 330 form single color images which are combined into a multi-color image 880 by a dichroic combiner cube 320 or some similar device.

### IV. VRD VISOR EMBODIMENTS

The system 100 can be implemented in a wide variety of different configurations and scales of operation. However, the original inspiration for the conception of the multiple diffuser concept occurred in the context of a VRD visor system 106 embodied as a VRD visor apparatus 116. A VRD visor apparatus 116 projects the image 880 directly onto the eyes of the user 90. The VRD visor apparatus 116 is a device that can be worn on the head of the user 90. In many embodiments, the VRD visor apparatus 116 can include sound as well as visual capabilities. Such embodiments can include multiple modes of operation, such as visual only, audio only, and audio-visual modes. When used in a non-visual mode, the VRD apparatus 116 can be configured to look like ordinary headphones.

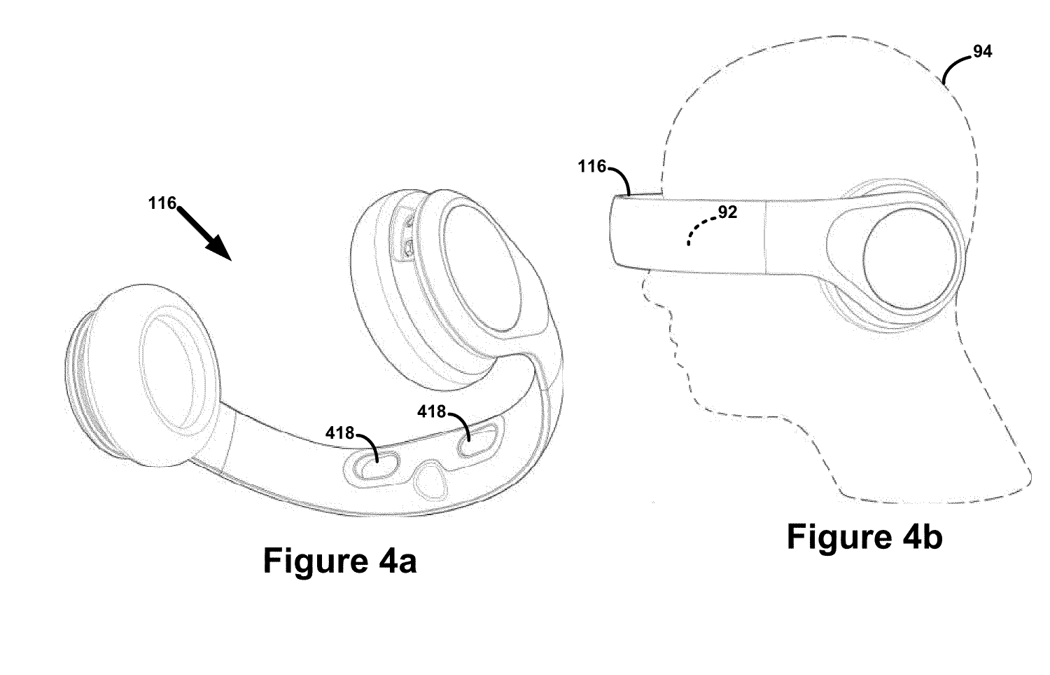

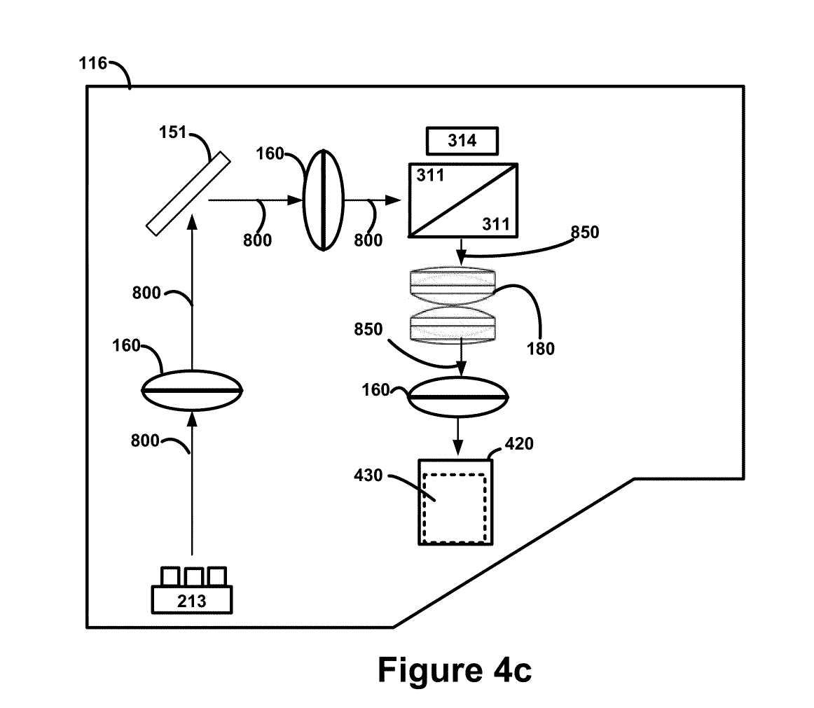

FIG. 4a is a perspective diagram illustrating an example of a VRD visor apparatus 116. Two VRD eyepieces 418 provide for directly projecting the image 880 onto the eyes of the user 90. The “eyepiece” 418 is essentially a passageway for light to travel between the plate 430 and the eye 92 of the viewer. As illustrated in FIGS. 1b-1f, the plate 430 is the last object that the image 880 hits before reaching the eye 92 of the viewer 96. The image 880 hits the plate 430 twice (FIGS. 1c and 1 e). The image 880 hits the curved mirror 420 only once (FIG. 1d). As illustrated by the front i.e. eye facing view of FIG. 1l, the configuration of plate 430 and curved mirror 420 can form a virtual eyepiece in a VRD display.

FIG. 4b is a side view diagram illustrating an example of a VRD visor apparatus 116 being worn on the head 94 of a user 90. The eyes 92 of the user 90 are blocked by the apparatus 116 itself, with the apparatus 116 in a position to project the image 880 on the eyes 92 of the user 90.

FIG. 4c is a component diagram illustrating an example of a VRD visor apparatus 116 for the left eye 92. A mirror image of FIG. 4c would pertain to the right eye 92.

A 3 LED light source 213 generates partially coherent light 803 that passes through a condensing lens 160 which directs the light 800 to a mirror 151 which reflects the light 800 to a shaping lens 160 prior to the entry of the light 800 into an imaging assembly 300 comprised of two TIR prisms 311 and a DMD 314. The interim image 850 from the imaging assembly 300 passes through two doublets 180 and another lens 160 that focuses the interim image 850 into a final image 880 that is viewable to the user 90 through the plate 430/mirror 420 configuration.

### V. ALTERNATIVE EMBODIMENTS

No patent application can expressly disclose in words or in drawings, all of the potential embodiments of an invention. Variations of known equivalents are implicitly included. In accordance with the provisions of the patent statutes, the principles, functions, and modes of operation of the systems 100, methods 900, and apparatuses 110 (collectively the “system” 100) are explained and illustrated in certain preferred embodiments. However, it must be understood that the inventive systems 100 may be practiced otherwise than is specifically explained and illustrated without departing from its spirit or scope.

The description of the system 100 provided above and below should be understood to include all novel and non-obvious alternative combinations of the elements described herein, and claims may be presented in this or a later application to any novel non-obvious combination of these elements. Moreover, the foregoing embodiments are illustrative, and no single feature or element is essential to all possible combinations that may be claimed in this or a later application.

The system 100 represents a substantial improvement over prior art display technologies. Just as there are a wide range of prior art display technologies, the system 100 can be similarly implemented in a wide range of different ways. The innovation of utilizing a tandem of a partially transparent plate 430 and curved mirror 420 can be implemented at a variety of different scales, utilizing a variety of different display technologies, in both immersive and augmenting contexts, and in both one-way (no sensor feedback from the user 90) and two-way (sensor feedback from the user 90) embodiments.

A. Variations of Scale

Display devices can be implemented in a wide variety of different scales. The monster scoreboard at EverBanks Field (home of the Jacksonville Jaguars) is a display system that is 60 feet high, 362 feet long, and comprised of 35.5 million LED bulbs. The scoreboard is intended to be viewed simultaneously by tens of thousands of people. At the other end of the spectrum, the GLYPH™ visor by Avegant Corporation is a device that is worn on the head of a user and projects visual images directly in the eyes of a single viewer. Between those edges of the continuum are a wide variety of different display systems. While the specification motivations for the system 100 are very much grounded in visor systems 105 and particularly VRD visor systems 106, that is not to say that the concepts have no utility outside those contexts.

The system 100 can be potentially implemented in a wide variety of different scales or for the structures to be used to serve different purposes.

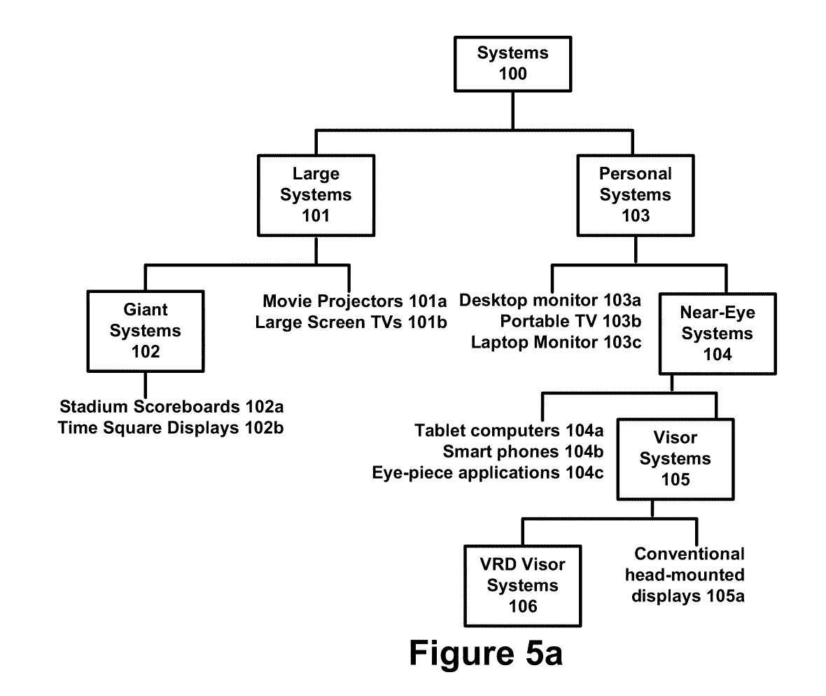

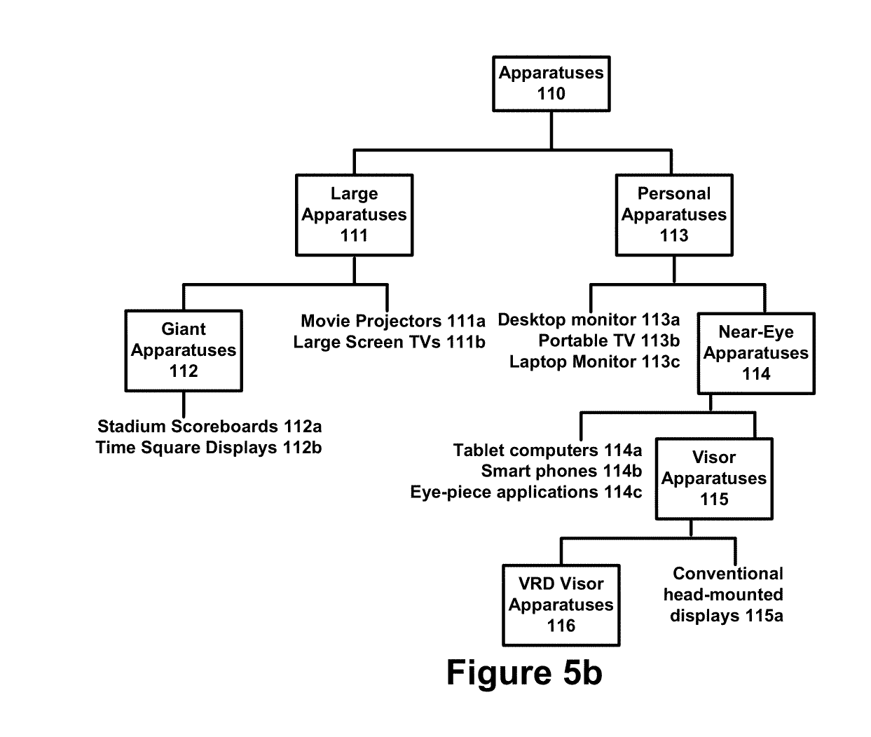

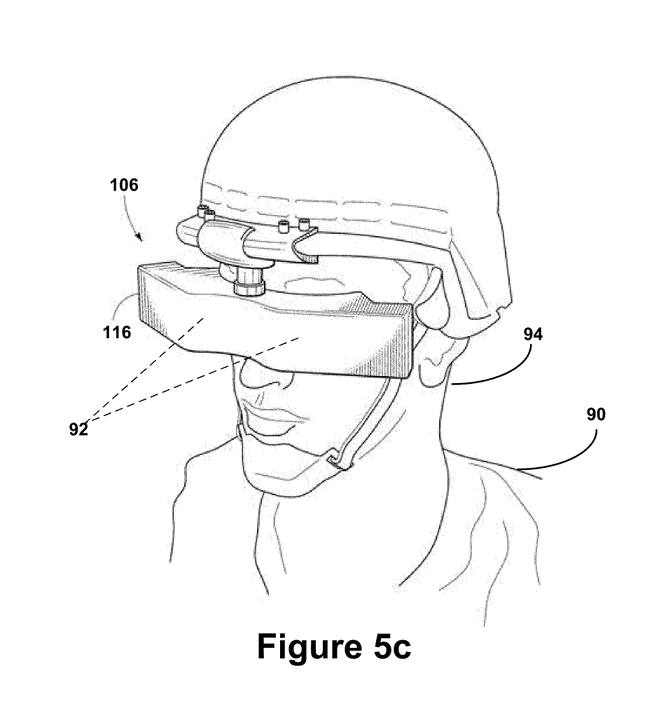

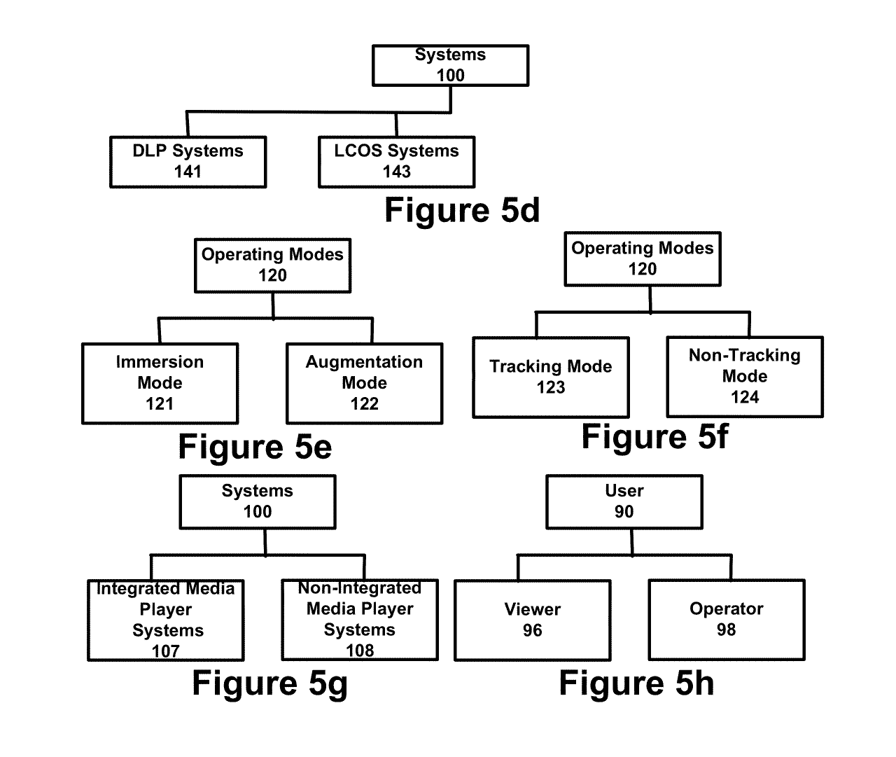

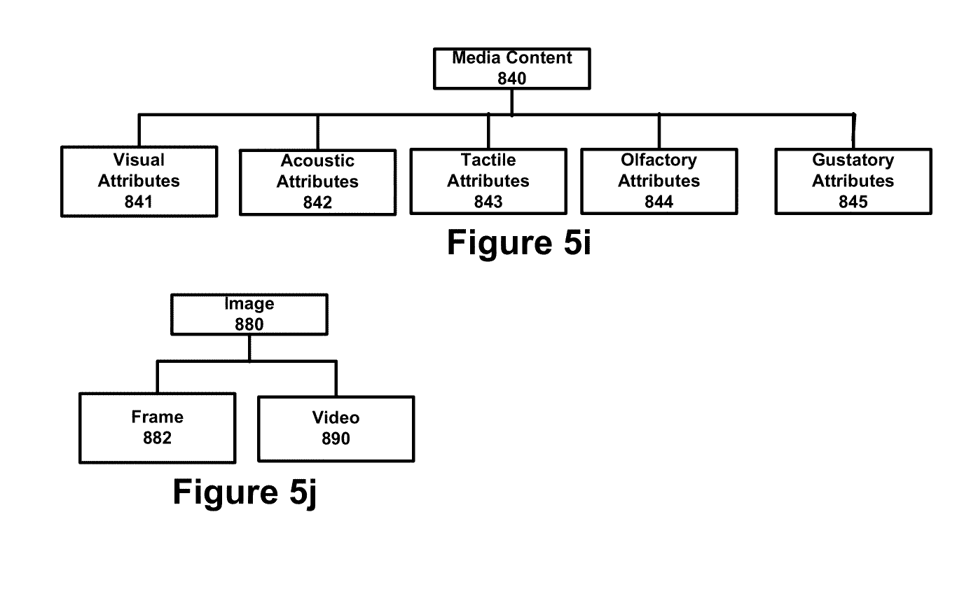

FIG. 5a is a hierarchy diagram illustrating various categories and subcategories pertaining to the scale of implementation for display systems generally, and the system 100 specifically. As illustrated in FIG. 5a, the system 100 can be implemented as a large system 101 or a personal system 103

1. Large Systems

A large system 101 is intended for use by more than one simultaneous user 90. Examples of large systems 101 include movie theater projectors, large screen TVs in a bar, restaurant, or household, and other similar displays. Large systems 101 include a subcategory of giant systems 102, such as stadium scoreboards 102a, the Time Square displays 102b, or other or the large outdoor displays such as billboards off the expressway.

2. Personal Systems

A personal system 103 is an embodiment of the system 100 that is designed to for viewing by a single user 90. Examples of personal systems 103 include desktop monitors 103a, portable TVs 103b, laptop monitors 103c, and other similar devices. The category of personal systems 103 also includes the subcategory of near-eye systems 104.

a. Near-Eye Systems

A near-eye system 104 is a subcategory of personal systems 103 where the eyes of the user 90 are within about 12 inches of the display. Near-eye systems 104 include tablet computers 104a, smart phones 104b, and eye-piece applications 104c such as cameras, microscopes, and other similar devices. The subcategory of near-eye systems 104 includes a subcategory of visor systems 105.

b. Visor Systems

A visor system 105 is a subcategory of near-eye systems 104 where the portion of the system 100 that displays the visual image 200 is actually worn on the head 94 of the user 90. Examples of such systems 105 include virtual reality visors, Google Glass, and other conventional head-mounted displays 105a. The category of visor systems 105 includes the subcategory of VRD visor systems 106.

c. VRD Visor Systems

A VRD visor system 106 is an implementation of a visor system 105 where visual images 200 are projected directly on the eyes of the user. The technology of projecting images directly on the eyes of the viewer is disclosed in a published patent application titled “IMAGE GENERATION SYSTEMS AND IMAGE GENERATING METHODS” (U.S. Ser. No. 13/367,261) that was filed on Feb. 6, 2012, the contents of which are hereby incorporated by reference. It is anticipated that a VRD visor system 106 is particularly well suited for the implementation of the multiple diffuser 140 approach for reducing the coherence of light 210.

3. Integrated Apparatus

Media components tend to become compartmentalized and commoditized over time. It is possible to envision display devices where an illumination assembly 120 is only temporarily connected to a particular imaging assembly 160. However, in most embodiments, the illumination assembly 120 and the imaging assembly 160 of the system 100 will be permanently (at least from the practical standpoint of users 90) into a single integrated apparatus 110. FIG. 5b is a hierarchy diagram illustrating an example of different categories and subcategories of apparatuses 110. FIG. 5b closely mirrors FIG. 5a. The universe of potential apparatuses 110 includes the categories of large apparatuses 111 and personal apparatuses 113. Large apparatuses 111 include the subcategory of giant apparatuses 112. The category of personal apparatuses 113 includes the subcategory of near-eye apparatuses 114 which includes the subcategory of visor apparatuses 115. VRD visor apparatuses 116 comprise a category of visor apparatuses 115 that implement virtual retinal displays, i.e. they project visual images 200 directly into the eyes of the user 90.

FIG. 5c is a diagram illustrating an example of a perspective view of a VRD visor system 106 embodied in the form of an integrated VRD visor apparatus 116 that is worn on the head 94 of the user 90. Dotted lines are used with respect to element 92 because the eyes 92 of the user 90 are blocked by the apparatus 116 itself in the illustration.

B. Different Categories of Display Technology

The prior art includes a variety of different display technologies, including but not limited to DLP (digital light processing), LCD (liquid crystal displays), and LCOS (liquid crystal on silicon). FIG. 5d, which is a hierarchy diagram illustrating different categories of the system 100 based on the underlying display technology in which the two (or more) diffusers 282 separated by a gap 290 can be implemented. As illustrated in FIG. 5d, the system 100 can be implemented as a DLP system 141, an LCOS system 143, and an LCD system 142. The system 100 can also be implemented in other categories and subcategories of display technologies.

C. Immersion vs. Augmentation

FIG. 5e is a hierarchy diagram illustrating a hierarchy of systems 100 organized into categories based on the distinction between immersion and augmentation. Some embodiments of the system 100 can have a variety of different operating modes 120. An immersion mode 121 has the function of blocking out the outside world so that the user 90 is focused exclusively on what the system 100 displays to the user 90. In contrast, an augmentation mode 122 is intended to display visual images 200 that are superimposed over the physical environment of the user 90. The distinction between immersion and augmentation modes of the system 100 is particularly relevant in the context of near-eye systems 104 and visor systems 105.

Some embodiments of the system 100 can be configured to operate either in immersion mode or augmentation mode, at the discretion of the user 90. While other embodiments of the system 100 may possess only a single operating mode 120.

D. Display Only vs. Display/Detect/Track/Monitor

Some embodiments of the system 100 will be configured only for a one-way transmission of optical information. Other embodiments can provide for capturing information from the user 90 as visual images 880 and potentially other aspects of a media experience are made accessible to the user 90. FIG. 5f is a hierarchy diagram that reflects the categories of a one-way system 124 (a non-sensing operating mode 124) and a two-way system 123 (a sensing operating mode 123). A two-way system 123 can include functionality such as retina scanning and monitoring. Users 90 can be identified, the focal point of the eyes 92 of the user 90 can potentially be tracked, and other similar functionality can be provided. In a one-way system 124, there is no sensor or array of sensors capturing information about or from the user 90.

E. Media Players—Integrated vs. Separate

Display devices are sometimes integrated with a media player. In other instances, a media player is totally separate from the display device. By way of example, a laptop computer can include in a single integrated device, a screen for displaying a movie, speakers for projecting the sound that accompanies the video images, a DVD or BLU-RAY player for playing the source media off a disk. Such a device is also capable of streaming

FIG. 5g is a hierarchy diagram illustrating a variety of different categories of systems 100 based on the whether the system 100 is integrated with a media player or not. An integrated media player system 107 includes the capability of actually playing media content as well as displaying the image 880. A non-integrated media player system 108 must communicate with a media player in order to play media content.

F. Users—Viewers vs. Operators

FIG. 5h is a hierarchy diagram illustrating an example of different roles that a user 90 can have. A viewer 96 can access the image 880 but is not otherwise able to control the functionality of the system 100. An operator 98 can control the operations of the system 100, but cannot access the image 880. In a movie theater, the viewers 96 are the patrons and the operator 98 is the employee of the theater.

G. Attributes of Media Content

As illustrated in FIG. 5i, media content 840 can include a wide variety of different types of attributes. A system 100 for displaying an image 880 is a system 100 that plays media content 840 with a visual attribute 841. However, many instances of media content 840 will also include an acoustic attribute 842 or even a tactile attribute. Some new technologies exist for the communication of olfactory attributes 844 and it is only a matter of time before the ability to transmit gustatory attributes 845 also become part of a media experience in certain contexts.

As illustrated in FIG. 5j, some images 880 are parts of a larger video 890 context. In other contexts, an image 880 can be stand-alone still frame 882.

### VI. GLOSSARY/DEFINITIONS

Table 1 below sets forth a list of element numbers, names, and descriptions/definitions.

| # | Name | Definition/Description |
|---|---|---|
| 90 | User | A user 90 is a viewer 96 and/or operator 98 of the system 100. The |
| | | user 90 is typically a human being. In alternative embodiments, users |
| | | 90 can be different organisms such as dogs or cats, or even automated |
| | | technologies such as expert systems, artificial intelligence |
| | | applications, and other similar “entities”. |
| 92 | Eye | An organ of the user 90 that provides for the sense of sight. The eye |
| | | consists of different portions including but not limited to the sclera, iris, |
| | | cornea, pupil, and retina. Some embodiments of the system 100 |
| | | involve a VRD visor apparatus 116 that can project the desired image |
| | | 880 directly onto the eye 92 of the user 90. |
| 94 | Head | The portion of the body of the user 90 that includes the eye 92. Some |
| | | embodiments of the system 100 can involve a visor apparatus 115 that |
| | | is worn on the head 94 of the user 90. |
| 96 | Viewer | A user 90 of the system 100 who views the image 880 provided by the |
| | | system 100. All viewers 96 are users 90 but not all users 90 are |
| | | viewers 96. The viewer 96 does not necessarily control or operate the |
| | | system 100. The viewer 96 can be a passive beneficiary of the system |
| | | 100, such as a patron at a movie theater who is not responsible for the |
| | | operation of the projector or someone wearing a visor apparatus 115 |
| | | that is controlled by someone else. |
| 98 | Operator | A user 90 of the system 100 who exerts control over the processing of |
| | | the system 100. All operators 98 are users 90 but not all users 90 are |
| | | operators 98. The operator 98 does not necessarily view the images |
| | | 880 displayed by the system 100 because the operator 98 may be |
| | | someone operating the system 100 for the benefit of others who are |
| | | viewers 96. For example, the operator 98 of the system 100 may be |
| | | someone such as a projectionist at a movie theater or the individual |
| | | controlling the system 100. |
| 100 | System | A collective configuration of assemblies, subassemblies, components, |
| | | processes, and/or data that provide a user 90 with the functionality of |
| | | engaging in a media experience such as viewing an image 890. Some |
| | | embodiments of the system 100 can involve a single integrated |
| | | apparatus 110 hosting all components of the system 100 while other |
| | | embodiments of the system 100 can involve different non-integrated |
| | | device configurations. Some embodiments of the system 100 can be |
| | | large systems 102 or even giant system 101 while other embodiments |
| | | of the system 100 can be personal systems 103, such as near-eye |
| | | systems 104, visor systems 105, and VRD visor systems 106. |
| | | Systems 100 can also be referred to as media systems 100 or display |
| | | systems 100. |
| 101 | Giant System | An embodiment of the system 100 intended to be viewed |
| | | simultaneously by a thousand or more people. Examples of giant |
| | | systems 101 include scoreboards at large stadiums, electronic |
| | | billboards such the displays in Time Square in New York City, and |
| | | other similar displays. A giant system 100 is a subcategory of large |
| | | systems 102. |
| 102 | Large System | An embodiment of the system 100 that is intended to display an image |
| | | 880 to multiple users 90 at the same time. A large system 102 is not |
| | | a personal system 103. The media experience provided by a large |
| | | system 102 is intended to be shared by a roomful of viewers 96 using |
| | | the same illumination assembly 200, imaging assembly 300, and |
| | | projection assembly 400. Examples of large systems 102 include but |
| | | are not limited to a projector/screen configuration in a movie theater, |
| | | classroom, or conference room; television sets in sports bar, airport, |
| | | or residence; and Scoreboard displays at a stadium. Large systems |
| | | 101 can also be referred to as large media systems 101. |
| 103 | Personal | A category of embodiments of the system 100 where the media |
| | System | experience is personal to an individual viewer 96. Common examples |
| | | of personal media systems include desktop computers (often referred |
| | | to as personal computers), laptop computers, portable televisions, and |
| | | near-eye systems 104. Personal systems 103 can also be referred to |
| | | as personal media systems 103. Near-eye systems 104 are a |
| | | subcategory of personal systems 103. |
| 104 | Near-Eye | A category of personal systems 103 where the media experience is |
| | System | communicated to the viewer 96 at a distance that is less than or equal |
| | | to about 12 inches (30.48 cm) away. Examples of near-eye systems |
| | | 103 include but are not limited to tablet computers, smart phones, and |
| | | visor media systems 105. Near-eye systems 104 can also be referred |
| | | to as near-eye media systems 104. Near-eye systems 104 include |
| | | devices with eye pieces such as cameras, telescopes, microscopes, etc. |
| 105 | Visor System | A category of near-eye media systems 104 where the device or at |
| | | least one component of the device is worn on the head 94 of the viewer |
| | | 96 and the image 880 is displayed in close proximity to the eye 92 of |
| | | the user 90. Visor systems 105 can also be referred to as visor media |
| | | systems 105. |
| 106 | VRD Visor | VRD stands for a virtual retinal display. VRDs can also be referred to |
| | System | as retinal scan displays (“RSD”) and as retinal projectors (“RP”). VRD |
| | | projects the image 880 directly onto the retina of the eye 92 of the |
| | | viewer 96. A VRD Visor System 106 is a visor system 105 that utilizes |
| | | a VRD to display the image 880 on the eyes 92 of the user 90. A VRD |
| | | visor system 106 can also be referred to as a VRD visor media system 106. |
| 110 | Apparatus | An at least substantially integrated device that provides the |
| | | functionality of the system 100. The apparatus 110 can include the |
| | | illumination assembly 200, the imaging assembly 300, and the |
| | | projection assembly 400. Some embodiments of the apparatus 110 |
| | | can include a media player 848 while other embodiments of the |
| | | apparatus 110 are configured to connect and communicate with an |
| | | external media player 848. Different configurations and connection |
| | | technologies can provide varying degrees of “plug and play” |
| | | connectivity that can be easily installed and removed by users 90. |
| 111 | Giant | An apparatus 111 implementing an embodiment of a giant system |
| | Apparatus | 101. Common examples of a giant apparatus 111 include the |
| | | scoreboards at a professional sports stadium or arena. |
| 112 | Large | An apparatus 110 implementing an embodiment of a large system |
| | Apparatus | 102. Common examples of large apparatuses 111 include movie |
| | | theater projectors and large screen television sets. A large apparatus |
| | | 111 is typically positioned on a floor or some other support structure. |
| | | A large apparatus 111 such as a flat screen TV can also be mounted |
| | | on a wall. |
| 113 | Personal Media | An apparatus 110 implementing an embodiment of a personal system |
| | Apparatus | 103. Many personal apparatuses 112 are highly portable and are |
| | | supported by the user 90. Other embodiments of personal media |
| | | apparatuses 112 are positioned on a desk, table, or similar surface. |
| | | Common examples of personal apparatuses 112 include desktop |
| | | computers, laptop computers, and portable televisions. |
| 114 | Near-Eye | An apparatus 110 implementing an embodiment of a near-eye system |
| | Apparatus | 104. Many near-eye apparatuses 114 are either worn on the head |
| | | (are visor apparatuses 115) or are held in the hand of the user 90. |
| | | Examples of near-eye apparatuses 114 include smart phones, tablet |
| | | computers, camera eye-pieces and displays, microscope eye-pieces |
| | | and displays, gun scopes, and other similar devices. |
| 115 | Visor | An apparatus 110 implementing an embodiment of a visor system 105. |
| | Apparatus | The visor apparatus 115 is worn on the head 94 of the user 90. The |
| | | visor apparatus 115 can also be referred simply as a visor 115. |
| 116 | VRD Visor | An apparatus 110 in a VRD visor system 105. Unlike a visor apparatus |
| | Apparatus | 114, the VRD visor apparatus 115 includes a virtual retinal display that |
| | | projects the visual image 200 directly on the eyes 92 of the user 90. |
| 120 | Operating | Some embodiments of the system 100 can be implemented in such a |
| | Modes | way as to support distinct manners of operation. In some |
| | | embodiments of the system 100, the user 90 can explicitly or implicitly |
| | | select which operating mode 120 controls. In other embodiments, the |
| | | system 100 can determine the applicable operating mode 120 in |
| | | accordance with the processing rules of the system 100. In still other |
| | | embodiments, the system 100 is implemented in such a manner that |
| | | supports only one operating mode 1200 with respect to a potential |
| | | feature. For example, some systems 100 can provide users 90 with a |
| | | choice between an immersion mode 121 and an augmentation mode |
| | | 122, while other embodiments of the system 100 may only support |
| | | one mode 120 or the other. |
| 121 | Immersion | An operating mode 120 of the system 100 in which the outside world |
| | | is at least substantially blocked off visually from the user 90, such that |
| | | the images 880 displayed to the user 90 are not superimposed over |
| | | the actual physical environment of the user 90. In many |
| | | circumstances, the act of watching a movie is intended to be an |
| | | immersive experience. |
| 122 | Augmentation | An operating mode 120 of the system 100 in which the image 880 |
| | | displayed by the system 100 is added to a view of the physical |
| | | environment of the user 90, i.e. the image 880 augments the real world, |
| | | i.e. an exterior environment image 650. Google Glass is an example |
| | | of an electronic display that can function in an augmentation mode. |
| 123 | Tracking | An operating mode 120 of the system 100 in which the system 100 |
| | or | captures information about the user 90 through one or more sensors. |
| | Sensing | Examples of different categories of sensing can include eye tracking |
| | | pertaining to the user's interaction with the displayed image 880, |
| | | biometric scanning such as retina scans to determine the identity of |
| | | the user 90, and other types of sensor readings/measurements. |
| 124 | Non-Tracking | An operating mode 120 of the system 100 in which the system 100 |
| | or | does not capture information about the user 90 or the user's |
| | Non-Sensing | experience with the displayed image 880. |
| 140 | Display | A technology for displaying images. The system 100 can be |
| | Technology | implemented using a wide variety of different display technologies. |
| 141 | DLP System | An embodiment of the system 100 that utilizes digital light processing |
| | | (DLP) to compose an image 880 from light 800. |
| 142 | LCD System | An embodiment of the system 100 that utilizes liquid crystal display |
| | | (LCD) to compose an image 880 from light 800. |
| 143 | LCOS System | An embodiment of the system 100 that utilizes liquid crystal on silicon |
| | | (LCOS) to compose an image 880 from light 800. |
| 150 | Supporting | Regardless of the context and configuration, a system 100 like any |
| | Components | electronic display is a complex combination of components and |
| | | processes. Light 800 moves quickly and continuously through the |
| | | system 100. Various supporting components 150 are used in different |
| | | embodiments of the system 100. A significant percentage of the |
| | | components of the system 100 can fall into the category of supporting |
| | | components 150 and many such components 150 can be referred to |
| | | as “conventional optics”. Supporting components 160 are necessary |
| | | in any implementation of the system 100 in that light 800 is an |
| | | important resource that must be controlled, constrained, directed, and |
| | | focused to be properly harnessed in the process of transforming light |
| | | 800 into an image 880 that is displayed to the user 90. The text and |
| | | drawings of a patent are not intended to serve as product blueprints. |
| | | One of ordinary skill in the art can devise multiple variations of |
| | | supplementary components 150 that can be used in conjunction with |
| | | the innovative elements listed in the claims, illustrated in the drawings, |
| | | and described in the text. |
| 151 | Mirror | An object that possesses at least a non-trivial magnitude of reflectivity |
| | | with respect to light. Depending on the context, a particular mirror |
| | | could be virtually 100% reflective while in other cases merely 50% |
| | | reflective. Mirrors 151 can be comprised of a wide variety of different |
| | | materials. |
| 152 | Dichroic Mirror | A mirror 151 with significantly different reflection or transmission |
| | | properties at two different wavelengths. |
| 160 | Lens | An object that possesses at least a non-trivial magnitude of |
| | | transmissivity. Depending on the context, a particular lens could be |
| | | virtually 100% transmissive while in other cases merely about 50% |
| | | transmissive. A lens 160 is often used to focus light 800. |
| 170 | Collimator | A device that narrows a beam of light 800. |
| 180 | Doublet | A double-lens paired together. Such an arrangement allows more |
| | | optical surfaces, thicknesses, and formulations, especially as the |
| | | space between lenses may be considered an “element.” With |
| | | additional degrees of freedom, optical designers have more latitude to |
| | | correct more optical aberrations more thoroughly. |
| 190 | Processor | A central processing unit (CPU) that is capable of carrying out the |
| | | instructions of a computer program. The system 100 can use one or |
| | | more processors 190 to communicate with and control the various |
| | | components of the system 100. |
| 191 | Power Source | A source of electricity for the system 100. Examples of power sources |
| | | include various batteries as well as power adaptors that provide for a |
| | | cable to provide power to the system 100. |
| 200 | Illumination | A collection of components used to supply light 800 to the imaging |
| | Assembly | assembly 300. Common example of components in the illumination |
| | | assembly 200 include light sources 210 and diffusers. The illumination |
| | | assembly 200 can also be referred to as an illumination subsystem 200. |
| 210 | Light Source | A component that generates light 800. There are a wide variety of |
| | | different light sources 210 that can be utilized by the system 100. |
| 211 | Multi-Prong | A light source 210 that includes more than one illumination element. |
| | Light Source | A 3-colored LED lamp 213 is a common example of a multi-prong light |
| | | source 212. |
| 212 | LED Lamp | A light source 210 comprised of a light emitting diode (LED). |
| 213 | 3 LED Lamp | A light source 210 comprised of three light emitting diodes (LEDs). In |
| | | some embodiments, each of the three LEDs illuminates a different |
| | | color, with the 3 LED lamp eliminating the use of a color wheel 240. |
| 214 | Laser | A light source 210 comprised of a device that emits light through a |
| | | process of optical amplification based on the stimulated emission of |
| | | electromagnetic radiation. |
| 215 | OLED Lamp | A light source 210 comprised of an organic light emitting diode |
| | | (OLED). |
| 216 | CFL Lamp | A light source 210 comprised of a compact fluorescent bulb. |
| 217 | Incandescent | A light source 210 comprised of a wire filament heated to a high |
| | Lamp | temperature by an electric current passing through it. |
| 218 | Non-Angular | A light source 210 that projects light that is not limited to a specific |
| | Dependent Lamp | angle. |
| 219 | Arc Lamp | A light source 210 that produces light by an electric arc. |
| 230 | Light Location | A location of a light source 210, i.e. a point where light originates. |
| | | Configurations of the system 100 that involve the projection of light |
| | | from multiple light locations 230 can enhance the impact of the |
| | | diffusers 282. |
| 240 | Color Wheel | A spinning wheel that can be used in a DLP system 141 to infuse color |
| | | into the image 880. |
| 300 | Imaging | A collective assembly of components, subassemblies, processes, and |
| | Assembly | light 800 that are used to fashion the image 880 from light 800. In |
| | | many instances, the image 880 initially fashioned by the imaging |
| | | assembly 300 can be modified in certain ways as it is made accessible |
| | | to the user 90. The modulator 320 is the component of the imaging |
| | | assembly 300 that is primarily responsible for fashioning an image 880 |
| | | from the light 800 supplied by the illumination assembly 200. |
| 310 | Prism | A substantially transparent object that is often has triangular bases. |
| | | Some display technologies 140 utilize one or more prisms 310 to direct |
| | | light 800 to a modulator 320 and to receive an image 880 from the |
| | | modulator 320. |
| 311 | TIR Prism | A total internal reflection (TIR) prism 310 used in a DLP 141 to direct |
| | | light to and from a DMD 324. |
| 312 | RTIR Prism | A reverse total internal reflection (RTIR) prism 310 used in a DLP 141 |
| | | to direct light to and from a DMD 324. |
| 320 | Modulator or | A device that regulates, modifies, or adjusts light 800. Modulators 320 |
| | Light Modulator | form an image 880 from the light 800 supplied by the illumination |
| | | assembly 200. |
| 321 | Transmissive- | A modulator 320 that fashions an image 880 from light 800 utilizing a |
| | Based Light | transmissive property of the modulator 320. Common examples of |
| | Modulator | reflection-based light modulators 322 include LCDs 330 and LCOSs 340. |
| 322 | Reflection- | A modulator 320 that fashions an image 880 from light 800 utilizing a |
| | Based Light | reflective property of the modulator 320. Common examples of |
| | Modulator | reflection-based light modulators 322 include DMDs 324 and LCOSs 340. |
| 324 | DMD | A reflection-based light modulator 322 commonly referred to as a |
| | | digital micro mirror device. A DMD 324 is typically comprised of a |
| | | several thousand microscopic mirrors arranged in an array on a |
| | | processor 190, with the individual microscopic mirrors corresponding |
| | | to the individual pixels in the image 880. |
| 330 | LCD Panel or | A light modulator 320 in an LCD (liquid crystal display). A liquid crystal |
| | LCD | display that uses the light modulating properties of liquid crystals. Each |
| | | pixel of an LCD typically consists of a layer of molecules aligned |
| | | between two transparent electrodes, and two polarizing filters (parallel |
| | | and perpendicular), the axes of transmission of which are (in most of |
| | | the cases) perpendicular to each other. Without the liquid crystal |
| | | between the polarizing filters, light passing through the first filter would |
| | | be blocked by the second (crossed) polarizer. Some LCDs are |
| | | transmissive while other LCDs are transflective. |
| 340 | LCOS Panel or | A light modulator 320 in an LCOS (liquid crystal on silicon) display. A |
| | LCOS | hybrid of a DMD 324 and an LCD 330. Similar to a DMD 324, except |
| | | that the LCOS 326 uses a liquid crystal layer on top of a silicone |
| | | backplane instead of individual mirrors. An LCOS 244 can be |
| | | transmissive or reflective. |
| 350 | Dichroic | A device used in an LCOS or LCD display that combines the different |
| | Combiner | colors of light 800 to formulate an image 880. |
| | Cube | |
| 400 | Projection | A collection of components used to make the image 880 accessible to |
| | Assembly | the user 90. The projection assembly 400 includes a display 410. The |
| | | projection assembly 400 can also include various supporting |
| | | components 150 that focus the image 880 or otherwise modify the |
| | | interim image 850 transforming it into the image 880 that is displayed |
| | | to one or more users 90. The projection assembly 400 can also be |
| | | referred to as a projection subsystem 400. |
| 410 | Display or | An assembly, subassembly, mechanism, or device by which visual |
| | Screen | image 200 is made accessible to the user 90. The display component |
| | | 120 can be in the form of a panel 122 that is viewed by the user 90 or |
| | | a screen 126 onto which the visual image 200 is projected onto by a |
| | | projector 124. In some embodiments, the display component 120 is a |
| | | retinal projector 128 that projects the visual image 200 directly onto |
| | | the eyes 92 of the user 90. |
| 412 | Active Screen | A display screen 410 powered by electricity that displays the image 880. |
| 414 | Passive Screen | A non-powered surface on which the image 880 is projected. A |
| | | conventional movie theater screen is a common example of a passive |
| | | screen 412. |
| 416 | Eyepiece | A display 410 positioned directly in front of the eye 92 of an individual |
| | | user 90. |
| 418 | VRD Eyepiece | An “eyepiece” 416 that provides for directly projecting the image 880 |
| | or VRD Display | on the eyes 92 of the user 90. A VRD eyepiece 418 can also be |
| | | referred to as a VRD display 418. A VRD eyepiece 418 is typically just |
| | | a position for the eye 92, as the partially transparent plate 430 reflects |
| | | the image 880 directly onto the eye 92 of the viewer 96. |
| 420 | Curved Mirror | An at least partially reflective surface that in conjunction with the |
| | | partially transparent plate 430 projects the image 880 onto the eye 92 |
| | | of the viewer 96. The curved mirror 420 can perform additional |
| | | functions in embodiments of the system 100 that include a tracking |
| | | mode 123 and/or an augmentation mode 122. |
| 422 | Half-Silvered | A curved mirror 410 that is half-silvered so that it is sufficiently |
| | Mirror | transparent to allow an exterior environment image 650 to pass |
| | | through the mirror. |
| 430 | Partially | A plate that is partially transparent and partially reflective. |
| | Transparent | Embodiments of the system 100 utilizing a tracking mode 123 will |
| | Plate or | require that the plate 430 be at least partially transparent with respect |
| | Plate | to infrared light as well. The plate 430 and curved mirror 420 function |
| | | to direct light 800 in a variety of different ways for a variety of different |
| | | purposes. See FIGS. 1b-1m. |
| 500 | Tracking | A collection of components that provide for the tracking of the eye 92 |
| | Assembly | of the viewer 96 while the viewer 96 is viewing an image 880. The |
| | | tracking assembly 500 can include an infrared camera 510, and |
| | | infrared lamp 520, and variety of supporting components 150. The |
| | | assembly 500 can also include a quad photodiode array or CCD. |
| 510 | Camera | A component that can generate an image of the eye 92 of the viewer |
| | | 96 for the purpose of tracking eye movements. The camera 510 is |
| | | typically an infrared camera 510. |
| 520 | Lamp | A light source for the camera. The lamp 520 is typically an infrared lamp. |
| 600 | Augmentation | A collection of components that provide for allowing or precluding an |
| | Assembly | exterior environment image 650 from reaching the eye 92 of the viewer 96. |
| 610 | Shutter | A device that provides for either allowing or disallowing exterior light |
| | Component | 832 from reaching the eyes 92 of the viewer 96 while the apparatus |
| | | 110 is being worn by the viewer 96. |
| 650 | Exterior | An image of the physical environment of the viewer 96.In |
| | Environment | augmentation mode 122, such images can be viewed by the viewer 96 |
| | Image | at the same time that the viewer 96 sees the displayed image 880. In |
| | | immersion mode 121, such images are blocked. |
| 800 | Light | Light 800 is the media through which an image is conveyed, and light |
| | | 800 is what enables the sense of sight. Light is electromagnetic |
| | | radiation that is propagated in the form of photons. |
| 830 | Infrared Light | Light 800 that falls in the infrared wavelength of the spectrum and this |
| | | is not visible to the human eye. Infrared light 830 is typically used by |
| | | the tracking assembly 500 for the purpose of tracking eye movement. |
| 832 | Exterior Light | Light 800 from the exterior environment of the viewer 96. The |
| | | augmentation assembly 600 may or may not permit such light to reach |
| | | the eyes 92 of viewer 96. |
| 840 | Media Content | The image 880 displayed to the user 90 by the system 100 can in |
| | | many instances, be but part of a broader media experience. A unit of |
| | | media content 840 will typically include visual attributes 841 and |
| | | acoustic attributes 842. Tactile attributes 843 are not uncommon in |
| | | certain contexts. It is anticipated that the olfactory attributes 844 and |
| | | gustatory attributes 845 may be added to media content 840 in the future. |
| 841 | Visual | Attributes pertaining to the sense of sight. The core function of the |
| | Attributes | system 100 is to enable users 90 to experience visual content such as |
| | | images 880 or video 890. In many contexts, such visual content will |
| | | be accompanied by other types of content, most commonly sound or |
| | | touch. In some instances, smell or taste content may also be included |
| | | as part of the media content 840. |
| 842 | Acoustic | Attributes pertaining to the sense of sound. The core function of the |
| | Attributes | system 100 is to enable users 90 to experience visual content such as |
| | | images 880 or video 890. However, such media content 840 will also |
| | | involve other types of senses, such as the sense of sound. The system |
| | | 100 and apparatuses 110 embodying the system 100 can include the |
| | | ability to enable users 90 to experience tactile attributes 843 included |
| | | with other types of media content 840. |
| 843 | Tactile | Attributes pertaining to the sense of touch. Vibrations are a common |
| | Attributes | example of media content 840 that is not in the form of sight or sound. |
| | | The system 100 and apparatuses 110 embodying the system 100 can |
| | | include the ability to enable users 90 to experience tactile attributes |
| | | 843 included with other types of media content 840. |
| 844 | Olfactory | Attributes pertaining to the sense of smell. It is anticipated that future |
| | Attributes | versions of media content 840 may include some capacity to engage |
| | | users 90 with respect to their sense of smell. Such a capacity can be |
| | | utilized in conjunction with the system 100, and potentially integrated |
| | | with the system 100. The iPhone app called oSnap is a current |
| | | example of gustatory attributes 845 being transmitted electronically. |
| 845 | Gustatory | Attributes pertaining to the sense of taste. It is anticipated that future |
| | Attributes | versions of media content 840 may include some capacity to engage |
| | | users 90 with respect to their sense of taste. Such a capacity can be |
| | | utilized in conjunction with the system 100, and potentially integrated |
| | | with the system 100. |
| 848 | Media Player | The system 100 for displaying the image 880 to one or more users 90 |
| | | may itself belong to a broader configuration of applications and |
| | | systems. A media player 848 is device or configuration of devices that |
| | | provide the playing of media content 840 for users. Examples of |
| | | media players 848 include disc players such as DVD players and BLU- |
| | | RAY players, cable boxes, tablet computers, smart phones, desktop |
| | | computers, laptop computers, television sets, and other similar |
| | | devices. Some embodiments of the system 100 can include some or |
| | | all of the aspects of a media player 848 while other embodiments of |
| | | the system 100 will require that the system 100 be connected to a |
| | | media player 848. For example, in some embodiments, users 90 may |
| | | connect a VRD apparatus 116 to a BLU-RAY player in order to access |
| | | the media content 840 on a BLU-RAY disc. In other embodiments, |
| | | the VRD apparatus 116 may include stored media content 840 in the |
| | | form a disc or computer memory component. Non-integrated versions |
| | | of the system 100 can involve media players 848 connected to the |
| | | system 100 through wired and/or wireless means. |
| 850 | Interim Image | The image 880 displayed to user 90 is created by the modulation of |
| | | light 800 generated by one or light sources 210 in the illumination |
| | | assembly 200. The image 880 will typically be modified in certain |
| | | ways before it is made accessible to the user 90. Such earlier versions |
| | | of the image 880 can be referred to as an interim image 850. |
| 880 | Image | A visual representation such as a picture or graphic. The system 100 |
| | | performs the function of displaying images 880 to one or more users |
| | | 90. During the processing performed by the system 100, light 800 is |
| | | modulated into an interim image 850, and subsequent processing by |
| | | the system 100 can modify that interim image 850 in various ways. At |
| | | the end of the process, with all of the modifications to the interim image |
| | | 850 being complete the then final version of the interim image 850 is |
| | | no longer a work in process, but an image 880 that is displayed to the |
| | | user 90. In the context of a video 890, each image 880 can be referred |
| | | to as a frame 882. |
| 882 | Frame | An image 880 that is a part of a video 890. |
| 890 | Video | In some instances, the image 880 displayed to the user 90 is part of a |
| | | sequence of images 880 can be referred to collectively as a video 890. |
| | | Video 890 is comprised of a sequence of static images 880 |
| | | representing snapshots displayed in rapid succession to each other. |
| | | Persistence of vision in the user 90 can be relied upon to create an |
| | | illusion of continuity, allowing a sequence of still images 880 to give |
| | | the impression of motion. The entertainment industry currently relies |
| | | primarily on frame rates between 24 FPS and 30 FPS, but the system |
| | | 100 can be implemented at faster as well as slower frame rates. |
| 900 | Method | A process for displaying an image 880 to a user 90. |
| 910 | Illumination | A process for generating light 800 for use by the system 100. The |
| | Method | illumination method 910 is a process performed by the illumination |
| | | assembly 200. |
| 920 | Imaging | A process for generating an interim image 850 from the light 800 |
| | Method | supplied by the illumination assembly 200. The imaging method 920 can |
| | | also involve making subsequent modifications to the interim image 850. |
| 930 | Display Method | A process for making the image 880 available to users 90 using the |
| | | interim image 850 resulting from the imaging method 920. The display |
| | | method 930 can also include making modifications to the interim |
| | | image 850. |

1. A system (100) for displaying an image (880) on an eye (92) of a viewer (96), said system (100) comprising:
A light source (210) that provides for supplying a plurality of light (800) to a modulator (320);
said modulator (320), wherein said modulator (320) provides for creating said image (880) from said light (800);
a curved mirror (420) and a partially transparent plate (430) that collectively provide for projecting said image (880) onto the eye (92) of the viewer (96).

2. The system (100) of claim 1, wherein said system (100) is a VRD visor apparatus (116).

3. The system (100) of claim 1, wherein said partially transparent plate (430) is the last component of said system (100) that the image (880) touches before reaching the eye (92) of the viewer (96).

4. The system (100) of claim 3, wherein said curved mirror (420) is the second last of component of said system (100) that the image (880) touches before reaching the eye (92) of the viewer (96).

5. The system (100) of claim 1, wherein the image (880) projected on the eye (92) of the viewer (96) comes into contact with said partially transparent plate (430) at least two times prior to reaching the eye (92) of the viewer (96).

6. The system (100) of claim 1, wherein the image (880) projected on the eye (92) of the viewer (96) comes into contact with said curved mirror (420) at least two times prior to reaching the eye (92) of the viewer (96).

7. The system (100) of claim 1, wherein said curved mirror (420) is a half-silvered mirror (422) that is at least partially transparent.

8. The system (100) of claim 7, wherein said half-silvered mirror (422) permits a plurality of exterior light (832) to reach the eye (92) of the viewer (90), allowing the viewer (90) to simultaneously view said image (880) generated by the modulator (320) and an exterior environment image (650).

9. The system (100) of claim 8, said system (100) further comprising a shutter component (610) that provides for blocking out said exterior light (832).

10. The system (100) of claim 9, wherein said shutter component (610) provides for being open and closed by the viewer (90).

11. The system (100) of claim 1, wherein said partially transparent plate (430) is at least partially transparent with respect to infrared light.

12. The system (100) of claim 11, said system (100) further comprising an infrared lamp (520) that provides for generating a plurality of infrared light (830) and an infrared camera (510), wherein said infrared camera (510) provides for tracking the eye (92) of the viewer (96).

13. The system (100) of claim 12, wherein said partially transparent plate (430) provides for directing infrared light (830) striking the eye (92) of the viewer (96) to said infrared camera (510).

14. The system (100) of claim 13, wherein at least a subset of said infrared light (830) traveling between the eye (92) of the viewer (96) to the infrared camera (510) does not come into contact with said curved mirror (420).

15. The system (100) of claim 12, wherein said infrared camera (510) is in communication with at least one of: (a) a quad photodiode array; and (b) a CCD.

16. An apparatus (110) that provides for being worn on a head (94) of a viewer (96) and projecting an image (880) onto an eye (92) of the viewer (96), said apparatus (110) comprising:
an illumination assembly (200) that includes a light source (210) for supplying a plurality of light (800) to a modulator (320);
an imaging assembly (300) that includes said modulator (320) for formulating the image (880) with the light (800) from said light source (210);
a projection assembly (400) that includes a partially transparent plate (430) and a curved mirror (420), wherein said projection assembly (400) provides for projecting the image (880) formulated by said modulator (320) onto the eye (92) of the viewer (96).

17. The apparatus (110) of claim 16, wherein said apparatus (110) includes an augmentation mode (122) that provides for viewing a plurality of exterior light (832) from an exterior environment (650) of the viewer (96) and a tracking mode (123) that provides for tracking the movement of the eye (92) of the viewer (96).

18. The apparatus (110) of claim 17, said apparatus (110) further comprising a shutter component (610) that provides for both allowing said exterior light (832) to reach the eye (92) of the user (96) and for precluding said exterior light (832) from reaching the eye (92) of the user (96).

19. The apparatus (110) of claim 17, said apparatus (110) further comprising an infrared lamp (520) and an infrared camera (510) that provide for tracking the movement of the eye (92) of the viewer (96).

20. A method (900) for displaying an image (880) on the eye (92) of a viewer (96), said method (900) comprising:
projecting (950) the image (880) on the eye (92) of the viewer (96) using a curved mirror (420) and a partially transparent plate (430) to direct the image (880) to the eye (920) of the user;
tracking (952) the movement of the eye (92) receiving the image (880); and
allowing (954) exterior light (832) with an exterior environment image (650) of the viewer (96) to reach the eye (92) of the viewer (96) while the image (880) is projected on the eye (92) of the viewer (96).
